(19) United States
(12) Patent Application Publication
(10) Pub. No.: US 2013/0159369 A1
(43) Pub. Date: Jun. 20, 2013

(54) APPARATUS AND METHOD FOR PERFORMING DISCRETE FOURIER TRANSFORM

(71) Applicant: Samsung Electronics Co., Ltd., Suwon-si (KR)

(72) Inventors: In-Tae KANG, Seongnam-si (KR); Su-Jin YOON, Suwon-si (KR); Sang-Min BAE, Yongin-si (KR); Jong-Han LIM, Seoul (KR)

(73) Assignee: SAMSUNG ELECTRONICS CO. LTD., Suwon-si (KR)

(21) Appl. No.: 13/718,599

(22) Filed: Dec. 18, 2012

(30) Foreign Application Priority Data
Dec. 19, 2011 (KR) 10-2011-0137582

(51) Int. Cl. G06F 17/14

(52) U.S. Cl. CPC G06F 17/141
USPC 708/405

(57) ABSTRACT

A Discrete Fourier Transform (DFT) apparatus is provided. The DFT apparatus includes a first delay, a second delay, an operator, and a multiplier. The first delay delays one sampling data by N-sample in a time axis when the one sampling data is input. The second delay delays an output value of a frequency component for a previous sampling data by 1-sample. The operator performs an operation based on the input one sampling data, the one sampling data delayed by the N-sample in the time axis, and the 1-sample delayed output value of the frequency component for the previous sampling data. The multiplier multiplies an output value from the operator by a twiddle factor

$${e}^{j \frac{2 π kn}{N}} .$$

Therefore, a complexity of a stream DFT operation can be reduced.

### PRIORITY

This application claims the benefit under 35 U.S.C. §119(a) of a Korean patent application filed on Dec. 19, 2011 in the Korean Intellectual Property Office and assigned Serial No. 10-2011-0137582, the entire disclosure of which is hereby incorporated by reference.

### BACKGROUND OF THE INVENTION

1. Field of the Invention

The present invention relates to Discrete Fourier Transform (DFT). More particularly, the present invention relates to an apparatus and a method for reducing an amount of a DFT operation when performing DFT.

2. Description of the Related Art

A mobile communication system uses a Discrete Fourier Transform (DFT) that uses samples of a time function in order to numerically calculate a Fourier Transform. Also, the DFT is used for calculating a Fourier series coefficient of an energy signal. An example where the DFT is used is a Long-Term Evolution (LTE) mobile communication system.

A Single-Carrier Frequency Division Multiple Access (SC-FDMA) modulator in a modem for communication of a 3^{rd} Generation (3G) LTE mobile communication system is described below. The modulator receives bit stream type data and converts the data into a symbol depending on a modulation type of the modulator. Next, the modulator performs the DFT on the symbol to convert the symbol into a signal in a frequency domain. After that, the modulator successively allocates signals of the frequency domain in a frequency of a predetermined region via subcarrier mapping, or allocates the signals of the frequency domain such that the signals have a predetermined interval. Next, the modulator performs Inverse Fast Fourier Transform (IFFT) on a subcarrier-mapped signal to output an IFFT signal.

The DFT is defined by Equation (1).

$$X [ k ] = {\sum }_{n = 0}^{N - 1} x [ n ] {e}^{- j \frac{2 π kn}{N}} , k = 0 , … , N - 1 \qquad Equation ( 1 )$$

where exponential values multiplied in each DFT are twiddle factors, and N denotes the number of DFT points (or DFT size). A complexity of the DFT for N inputs is 0(N²).

A more efficient algorithm for calculating the DFT can be realized as a combination of a plurality of DFTs. A Fast Fourier Transform (FFT) is a general term for these algorithms. In a case where a number of DFT points is a power of 2 (form of 2ₙ), the DFT and the IDFT are implemented in actual hardware using FFT algorithms such as radix-2, radix-4, radix-2̂2, split-radix algorithms, etc. for high speed operation while reducing an amount of operation. At this point, complexity is 0 (N*log N), so that an efficient structure whose complexity has improved compared with DFT is obtained.

The DFT/FFT of the related art processes a sample on an N-block basis. N serial sampling data in a time axis are converted into one parallel sampling data, and DFT/FFT is performed, so that N signals are output in a frequency axis. This is referred to as a block DFT/FFT.

FIG. 1 illustrates an 8-point DFT process according to the related art.

Referring to FIG. 1, in a case where an 8-point DFT is performed on 12 sampling data inputs whenever a new input value occurs in a time axis, 8 sampling data x[0] to x[7] are received in the time axis and DFT with a complexity of 0 (N×log N) is performed. After that, when sampling data x[8] is input, DFT with a complexity of 0 (N×log N) is performed together with the previous sampling data x[0] to x[7]. Likewise, DFT with a complexity of 0 (N×log N) is performed together with the previous sampling data whenever sampling data x[9], x[10], and x[11] are input, respectively. Hereinafter, performing DFT whenever each sampling data is input is referred to as ‘stream DFT’. That is, when DFT/FFT is performed on a sample basis, a complexity of 0 (N×log N) occurs every step. In a case where a block FFT is used, when the stream DFT is performed on M inputs with a complexity of 0 (M×N×log N) with M=N, it has a complexity of 0 (N²×log N).

When an N-point sample-by-sample Stream DFT operation is performed using a block FFT processor of the related art, N parallel block FFT processors are required. In the case where hardware complexity increases excessively or one block FFT processor is used, N sample processing delay exists every sampling data input and so a time delay becomes large. Consequently, a memory for buffering increases excessively and hardware complexity increases.

Therefore, there is a need for an apparatus and a method for reducing an amount of a DFT or an FFT operation whenever each sample data is input.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide an apparatus and a method for reducing an amount of operation in the case where performance of a Discrete Fourier Transform (DFT) or a Fast Fourier Transform (FFT) operation is required whenever each sample data is input.

Another aspect of the present invention is to provide an apparatus and a method for performing a DFT for reducing hardware complexity.

In accordance with an aspect of the present invention, a DFT apparatus is provided. The apparatus includes a first delay for delaying one sampling data by N-sample in a time axis when the one sampling data is input, a second delay for delaying an output value of a frequency component for a previous sampling data by 1-sample, an operator for performing an operation based on the input one sampling data, the one sampling data delayed by the N-sample in the time axis, and the 1-sample delayed output value of the frequency component for the previous sampling data, and a multiplier for multiplying an output value from the operator by a twiddle factor

$${e}^{j \frac{2 π kn}{N}} .$$

In accordance with another aspect of the present invention, a DFT apparatus is provided. The apparatus includes a first delay for delaying one sampling data by N-sample in a time axis when the one sampling data is input, a plurality of second delays for delaying an output value of a frequency component for a previous sampling data by 1-sample, a plurality of operators for performing an operation based on the input one sampling data, the one sampling data delayed by the N-sample in the time axis, and the 1-sample delayed output value of the frequency component for the previous sampling data, and a plurality of multipliers for multiplying each of output values from the plurality of operators by a twiddle factor

$${e}^{j \frac{2 π kn}{N}} .$$

In accordance with still another aspect of the present invention, a DFT method is provided. The method includes, when one sampling data is input, delaying, at a first delay, the one sampling data by N-sample in a time axis, delaying, at a second delay, an output value of a frequency component for a previous sampling data by 1-sample, performing, at an operator, an operation based on the input one sampling data, the one sampling data delayed by the N-sample in the time axis, and the 1-sample delayed output value of the frequency component for the previous sampling data, and multiplying, at a multiplier, an output value from the operator by a twiddle factor

$${e}^{j \frac{2 π kn}{N}} .$$

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a view illustrating an 8-point Discrete Fourier Transform (DFT) process according to the related art;

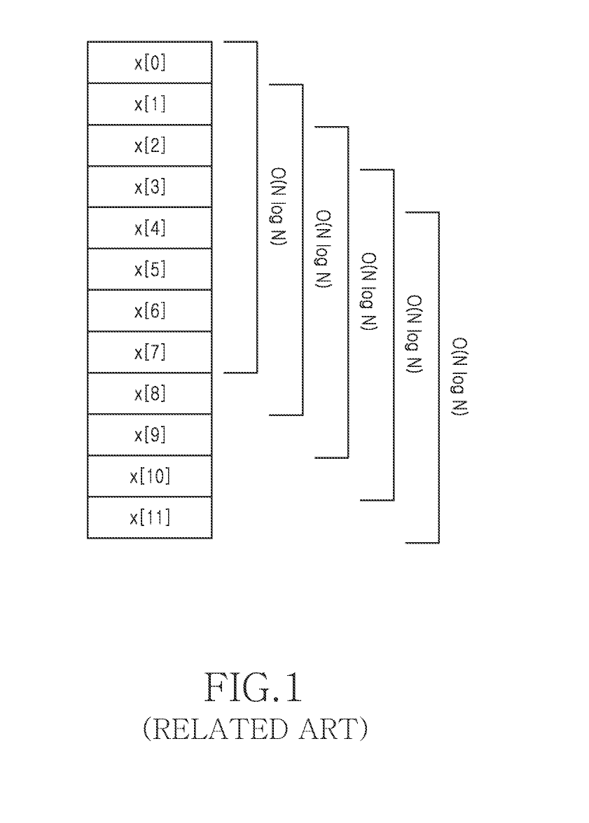

FIG. 2 is a view illustrating an apparatus for performing a stream DFT operation corresponding to one specific frequency component according to an exemplary embodiment of the present invention;

FIG. 3 is a view illustrating an apparatus for performing a stream DFT process corresponding to a plurality of specific frequency components according to an exemplary embodiment of the present invention;

FIG. 4 is a view illustrating an 8-point stream DFT process according to an exemplary embodiment of the present invention;

FIG. 5 is a flowchart illustrating a method for performing a stream DFT process according to an exemplary embodiment of the present invention;

FIG. 6 is a view illustrating a first primary synchronization signal and a second synchronization signal in a Long Term Evolution (LTE) system according to an exemplary embodiment of the present invention;

FIG. 7 is a view illustrating a stream DFT process for detecting a Primary Synchronization Signal (PSS) according to an exemplary embodiment of the present invention; and

FIG. 8 is a view illustrating a reference signal in time-frequency axes according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide an apparatus and a method for performing a Discrete Fourier Transform (DFT). Particularly, exemplary embodiments of the present invention consider a method for calculating DFT for a current input value and previous (N−1) time-axis inputs x[n-(N−1)], x[n−(N−2)], . . . , x[n] whenever one time-axis input x[n] is input. Since disadvantages of high complexity exist when block Fast Fourier Transform (FFT) is used as described above, an alternative for addressing this is proposed.

Also, in the case where mobile communication systems, such as WiMax, Institute of Electrical and Electronics Engineers (IEEE) 802.16m, and 3^{rd} Generation Partnership Project (3GPP) Long Term Evolution (LTE) that use an Orthogonal Frequency Division Multiplexing (OFDM) scheme and a Single Carrier Frequency Division Multiple Access (SC-FDMA) scheme, use FFT when analyzing a signal for various purposes. Such mobile communication systems may additionally use a stream DFT function while supplementing FFT. The stream DFT denotes a method for calculating DFT for a current input value and previous (N−1) time-axis inputs x[n−(N−1)], x[n−(N−2)], . . . , x[n] whenever one time-axis input x[n] is input.

An N-point stream DFT meets Equation (2) when a relation of DFT between N sampling data inputs having an offset by 1, that is, between {x[x], x[n+1], x[n+2], . . . , x[n+N−1]} and {x[n+1], x[n+2], . . . , x[n+N]} is considered.

$${X}_{n + 1} [ k ] = ( {X}_{n} [ k ] - x [ n ] + x [ n + N ] ) {e}^{j \frac{2 π kn}{N}} \\ for k = 0 , … , N - 1 \qquad Equation ( 2 )$$

where k is a subcarrier index, Xₙ₊₁ [k] is an output value for a k subcarrier in a frequency axis when (n+1)-th sampling data is input, x[n] is n-th sampling data value in a time axis, and

$${e}^{j \frac{2 π kn}{N}}$$

is a twiddle factor.

To derive Equation (2), cases where n=0 and n=1 are considered, respectively, for convenience. At this point, X₀[k], that is, an output value for a k subcarrier in a frequency axis when 0-th sampling data is input may be expressed by Equation (3).

$$\begin{matrix}{X}_{0} [ k ] = {\sum }_{n = 0}^{N - 1} x [ n ] {e}^{- j \frac{2 π}{N} nk} \\ = x [ 0 ] + {\sum }_{n = 1}^{N - 1} x [ n ] {e}^{- j \frac{2 π}{N} nk} \\ = x [ 0 ] + {\sum }_{n = 0}^{N - 2} x [ n + 1 ] {e}^{- j \frac{2 π}{N} ( n + 1 ) k}\end{matrix} \qquad Equation ( 3 )$$

Therefore, Equation (4) is met.

$${\sum }_{n = 0}^{N - 2} x [ n + 1 ] {e}^{- j \frac{2 π}{N} nk} = ( {X}_{0} [ k ] - x [ 0 ] ) {e}^{j \frac{2 π}{N} k} \qquad Equation ( 4 )$$

Likewise, X₁[k], that is, an output value for a k subcarrier in a frequency axis when first sampling data is input may be expressed by Equation (5).

$$\begin{matrix}{X}_{1} [ k ] = {\sum }_{n = 1}^{N - 1} x [ n + 1 ] {e}^{- j \frac{2 π}{N} nk} \\ = {\sum }_{n = 0}^{N - 2} x [ n + 1 ] {e}^{- j \frac{2 π}{N} nk} + x [ N ] {e}^{- j \frac{2 π}{N} ( N - 1 ) k} \\ = ( {X}_{0} [ k ] - x [ 0 ] ) {e}^{j \frac{2 π}{N} k} + x [ N ] {e}^{- j \frac{2 π}{N} ( N - k ) mod N} \\ = ( {X}_{0} [ k ] - x [ 0 ] + x [ N ] ) {e}^{j \frac{2 π}{N} k}\end{matrix} \qquad Equation ( 5 )$$

Since Equation (4) and Equation (5) are met for an arbitrary n and n+1, Equation (4) and Equation (5) may be generalized as in Equation (6).

$${X}_{n + 1} [ k ] = ( {X}_{n} [ k ] - x [ n ] + x [ n + N ] ) {e}^{j \frac{2 π}{N} k} \\ for k = 0 , … , N - 1 \qquad Equation ( 6 )$$

Equation (6) includes one adder, one subtractor, and one multiplier, and has a complexity of 0(1). Also, since a k-th frequency component (e.g., k-th subcarrier) in a (n+1)-th time in Equation (6) is a function of only a k-th frequency axis in an n-th time, it can be calculated separately from other frequency components. That is, in a case of calculating all N frequency axes components, it has a complexity of 0(N). In the case where only K≦N frequency component subset(s) are required, it has a complexity of 0(K).

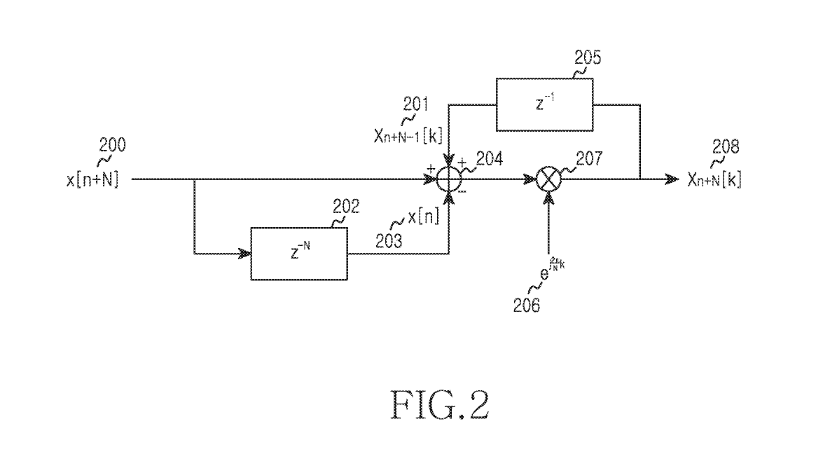

An example of Equation (6) realized in hardware is illustrated in FIG. 2.

FIG. 2 illustrates an apparatus for performing a stream DFT operation corresponding to one specific frequency component according to an exemplary embodiment of the present invention.

Referring to FIG. 2, a DFT operating apparatus includes a first delay 202, an operator 204, a second delay 205, and a multiplier 207.

(n+N)-th sample data x[n+N] 200 is used as an input of the operator 204 and the first delay 202. Meanwhile, x[n+N] 200 is N-sample delayed and used as an input of the operator 204. When x[n+N] 200 is N-sample delayed, it becomes x[n] 203. Generally, when the size of N is small, it may be realized in the form of a register and when the size of N is large, it may be realized using a memory. In addition, a final output value X_{n+N}[K] 208 corresponding to a k-th frequency component in an (n+N)-th time is 1-sample delayed and used as an input X_{n+N-1}[K] 201 of the operator 201. That is, X_{n+N-1}[K] 201 is an output value corresponding to a k-th frequency component in the previous time (n+N−1).

The first delay 202 delays the sample data x[n+N] 200 by N-sample (z^{-N}) to provide the same to the operator 204, and the second delay 205 delays the final output value X_{n+N}[K] 208 corresponding to a k-th frequency component in an (n+N)-th time by 1-sample (z⁻¹) to provide the same to the operator 204. At this point, the output value corresponding to 1-sample delayed (z⁻¹) k-th frequency component becomes X_{n+N-1}[K] 201.

The operator 204 receives a current sampling data value x[n+N] in a time axis, x[n] obtained by delaying x[n+N] by N-sample, and an output value X_{n+N-}1[K] in a frequency axis corresponding to a relevant frequency component in the previous time to calculate X_{n+N-1}[K]−x[n]+x[n+N] and outputs the same to the multiplier 207.

The multiplier 207 multiplies the output value X_{n+N-1}[K]−x[n]+x[n+N] from the operator 204 by a twiddle factor 206, that is,

$${e}^{j \frac{2 π}{N} k} ,$$

to output the same.

Therefore, an output value corresponding to a k-th frequency component in an (n+N)-th time becomes X_{n+N}[K] 208.

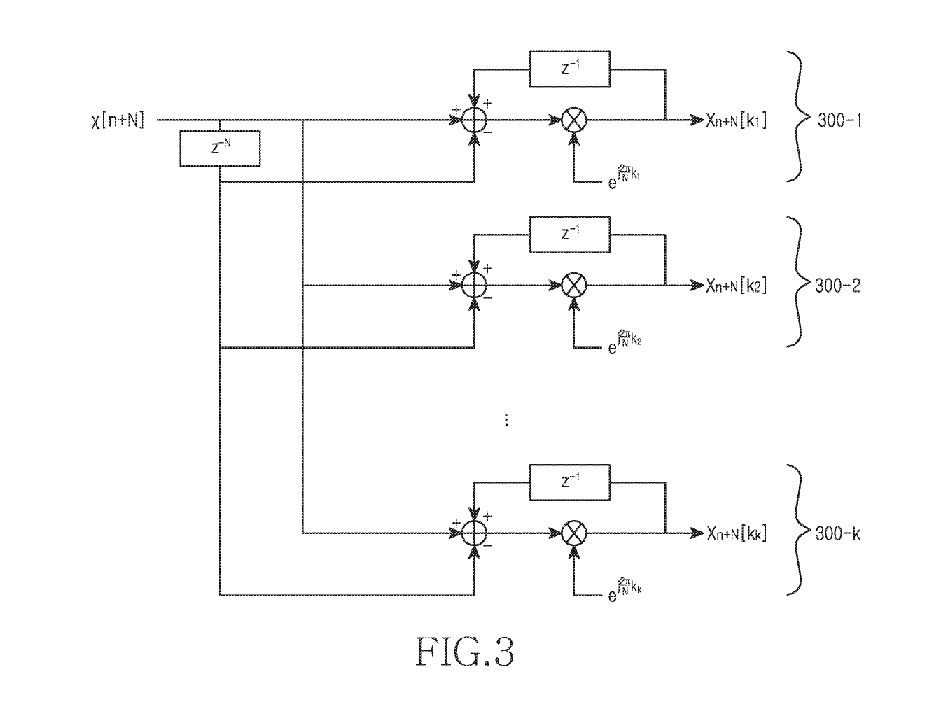

Though FIG. 2 illustrates an exemplary apparatus for performing DFT on a k-th one frequency component, in a case of calculating a plurality (K N) of frequency components {k_1, k_2, . . . , k_k} among N-point DFT, an apparatus may be alternatively be realized as in FIG. 3.

FIG. 3 illustrates an apparatus for performing a stream DFT process corresponding to a plurality of specific frequency components according to an exemplary embodiment of the present invention.

Referring to FIG. 3, the DFT operating apparatus includes a first delay used in common for a plurality of frequency components, operators for a plurality of frequency components, second delays, and multipliers.

That is, a DFT operating apparatus 300-1 performs a stream DFT operation on a first subcarrier, a DFT operating apparatus 300-2 performs a stream DFT operation on a second subcarrier, and a DFT operating apparatus 300-K performs a stream DFT operation on a K-th subcarrier.

Since an operation of each DFT operating apparatus is the same as the operation of the DFT operating apparatus of FIG. 2, detailed descriptions thereof are omitted for brevity.

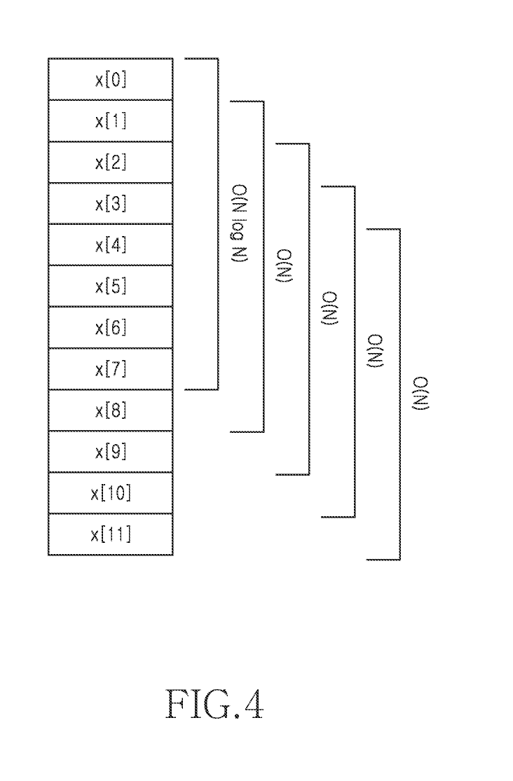

FIG. 4 illustrates an 8-point stream DFT process according to an exemplary embodiment of the present invention.

Referring to FIG. 4, in a case of performing an 8-point DFT whenever a new input value occurs with respect to 12 sampling data inputs in a time axis, 8 sampling data x[0] to x[7] are received in an initial time axis and a DFT with a complexity of 0 (N×log N) is performed. After that, when sampling data x[8] is input, a DFT with a complexity of 0 (N) is performed using a frequency axis output value for the previous relevant frequency component and N-sample delayed sampling data x[8]. Likewise, a DFT with a complexity of 0 (N) is performed using a frequency axis output value for the previous relevant frequency component and N-sample delayed sampling data whenever sample data x[9], x[10], and x[11] are input respectively.

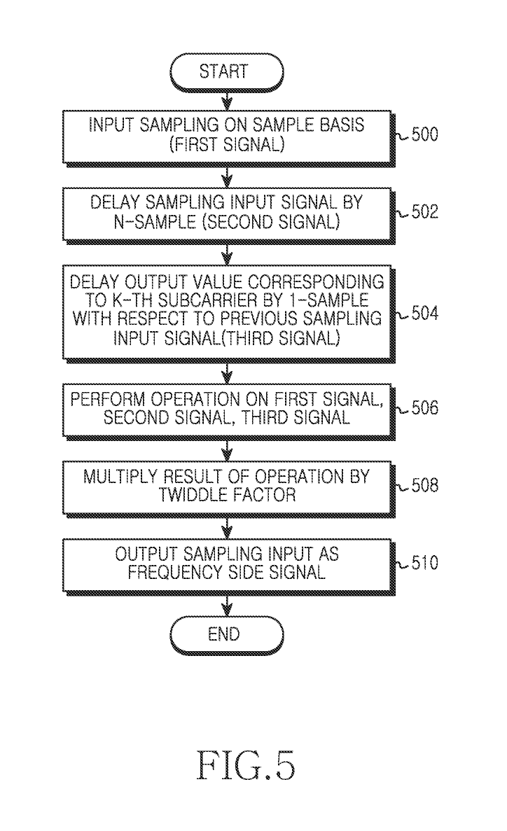

FIG. 5 is a flowchart illustrating a method for performing a stream DFT process according to an exemplary embodiment of the present invention.

Referring to FIG. 5, sampling data is input on a sample basis (referred to as a ‘first signal’) in step 500, and the sampling data is N-sample delayed (referred to as a ‘second signal’) in step 502.

Meanwhile, an output value corresponding to a k-th frequency component (or a subcarrier) is 1-sample delayed with respect to input previous sampling data in step 504 (referred to as a ‘third signal’).

After that, an operation is performed on the first input signal, the second input signal, and the third input signal based on Equation (6) in step 506, and a result of the operation is multiplied by a twiddle factor

$${e}^{j \frac{2 π kn}{N}}$$

in step 508.

After that, a signal in a frequency axis is output for current sampling data based on Equation (6) in step 510.

As described above, in the case where a calculation of K frequency components is required for M time-axis inputs using stream DFT, it has a complexity of 0 (M×K). In the case where M=N and all frequency axes calculation is required, it has a complexity of 0 (N²) corresponding to a complexity of a related-art DFT. That is, a related-art block DFT calculation using stream DFT is possible.

Also, block DFT can be realized using only a stream DFT structure of an exemplary embodiment of the present invention, but in the case where a form of supplementing the block DFT is taken, efficiency may be raised even more. That is, in the case where a block FFT having a complexity of 0 (N×log N) is used for initial N inputs, and stream DFT having a complexity of 0 (N) is used for input samples afterward, it is more efficient. Since the block FFT has a complexity of 0 (M×N×log N) for (M+N) inputs but the stream DFT has a complexity of 0 (N×log N)+0 (M×N), complexity per sample has a complexity of 0 (N×log N/M)+0 (N) compared to 0 (N×log N), and thus is more efficient.

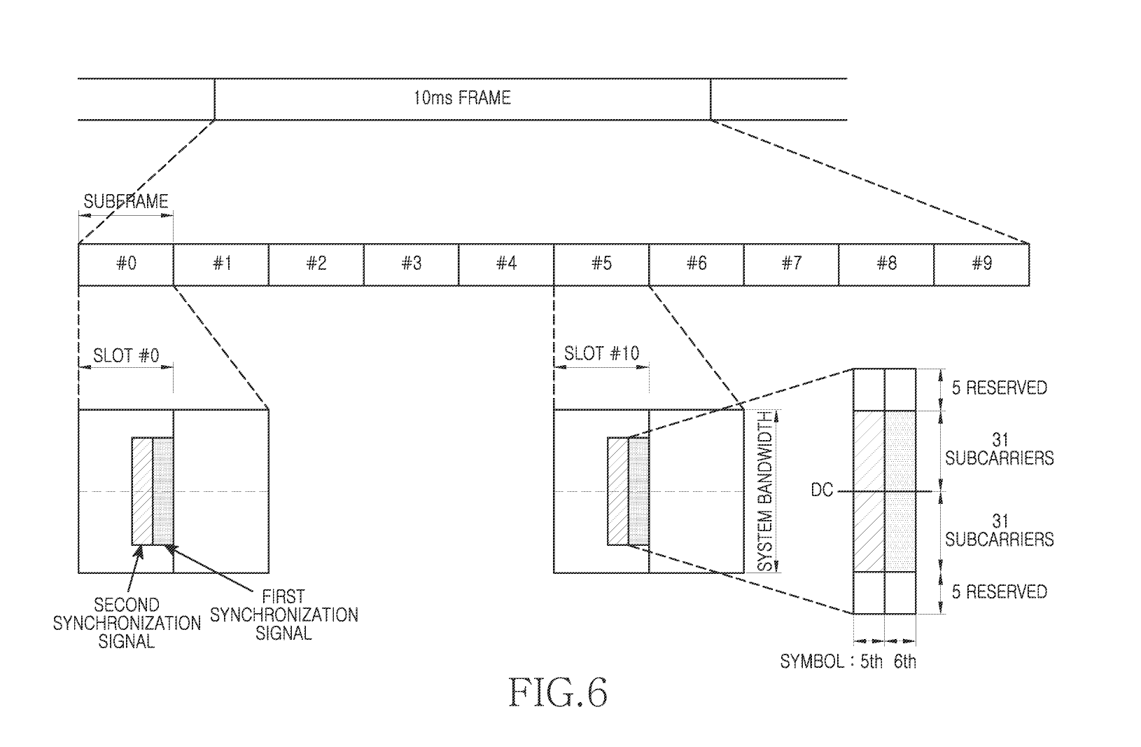

FIG. 6 illustrates a first primary synchronization signal and a second synchronization signal in an LTE system according to an exemplary embodiment of the present invention.

Referring to FIG. 6, in the case where monitoring is required for only a specific subcarrier set, a stream DFT structure is more efficient. Since block FFT has no method for separately calculating only a specific subcarrier set, it still has a complexity of 0 (M×N×log N) with respect to (M+N) inputs. However, in the case where frequency information for K<<N subcarriers is required, it has a complexity of 0 ((M+N)×K). In the case where block FFT is utilized simultaneously, it has a complexity of 0 (N×log N)+0 (M×K).

For a scenario requiring a DFT operation for only a specific frequency component, several scenarios for receiving 3GPP LTE downlink signals may be considered.

In an LTE system, a Primary Synchronization Signal (PSS) and a Secondary Synchronization Signal (SSS), which are synchronization signals, are positioned at a slot#0 and a slot#10 in a time axis, and a frequency axis uses 31 subcarriers for left and right, respectively, among a center 6 Resource Blocks (RBs) (72 subcarriers) excluding a DC subcarrier regardless of a bandwidth, and use Zadoff-Chu (ZC) sequence d(n), which is a frequency axis signal.

$${d}_{u} ( n ) = \{ \begin{matrix}{e}^{- j \frac{π un ( n + 1 )}{63}} n = 0 , 1 , … , 30 \\ {e}^{- j \frac{π un ( n + 1 ) ( n + 2 )}{63}} n = 31 , 32 , … 61\end{matrix} \qquad Equation ( 7 )$$

Here, for a u value, three ZC sequences having 25, 29, and 34 are used.

Since time synchronization is not obtained, the PSS signal is used for obtaining time synchronization of a 5 ms basis and a physical layer IDentifier (ID) using a non-coherent method. Since time synchronization is not obtained, FFT timing cannot be known, and also taking symbol-by-symbol FFT using block FFT with respect to N inputs cannot be used for a PSS detection algorithm for having to calculate a maximum correlation between symbols in sample-by-sample to calculate a 5 ms timing boundary.

Therefore, a related-art method calculated IFFT of a ZC sequence corresponding to u=25, 29, 34 in advance to generate a 5 ms boundary in a sample having a maximum correlation value in a time axis. However, when stream DFT is used, since DFT according to sample-by-sample can be calculated for only a portion corresponding to a center 62 subcarriers, a correlation method in a time axis using IFFT is not used, but a ZC sequence and a relevant subcarrier are directly multiplied in a frequency axis and then a sum is taken, so that a time sample corresponding to a maximum correlation can be calculated.

In summary, even in the case where the related-art block DFT processes using sample-by-sample, complexity is too high and the related-art block DFT cannot process in a frequency axis, when stream DFT is used, it can process in the frequency axis.

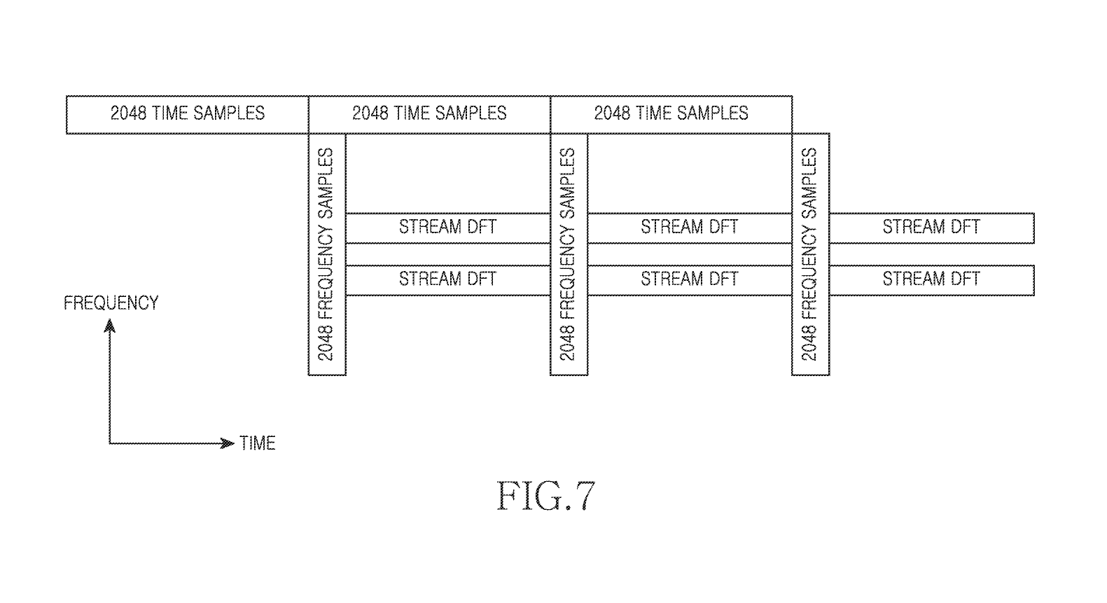

FIG. 7 illustrates a stream DFT process for detecting a PSS according to an exemplary embodiment of the present invention.

Referring to FIG. 7, a case where a bandwidth of 20 MHz is used in cooperation with a 2048 FFT is illustrated. A horizontal axis represents time and a vertical axis represents frequency. The case corresponds to a case of obtaining an output value by periodically using block FFT, and then using some desired subcarrier output values (62 subcarriers excluding a center DC subcarrier) as stream DFT inputs, and obtaining a DFT result for all samples inside a symbol section.

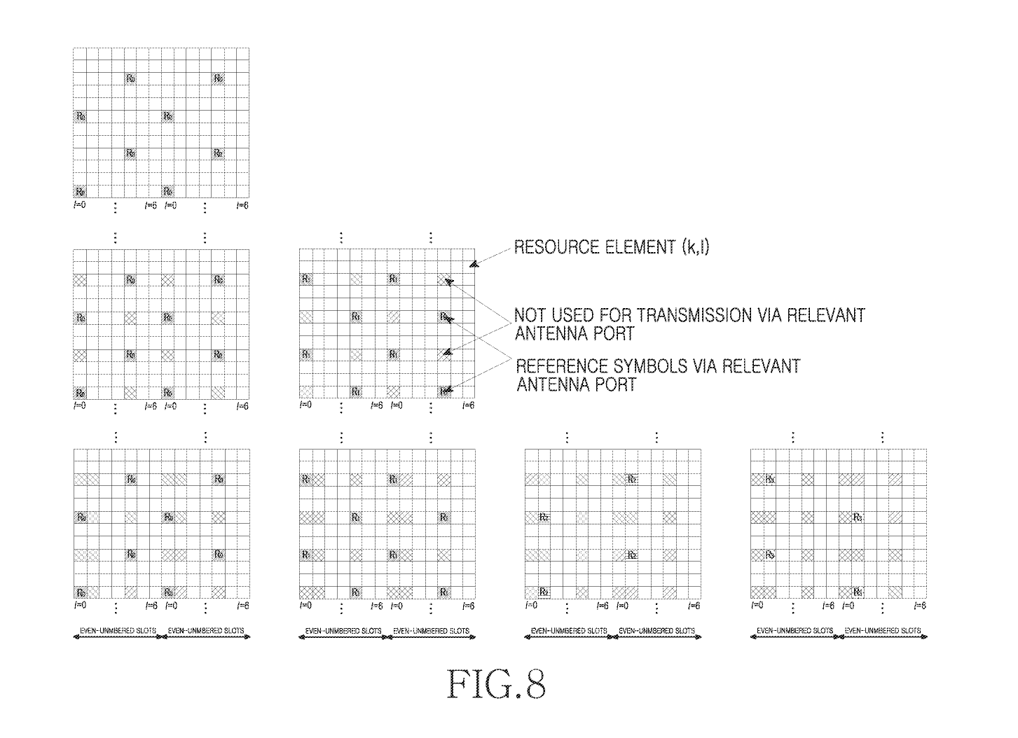

For another example, as in FIG. 8, in case of an LTE Reference Signal (RS), since only a portion of all subcarriers is allocated to a subcarrier, when an algorithm that uses only RS information excluding a data region exists, stream DFT may be usefully employed.

FIG. 8 illustrates a reference signal in time-frequency axes according to an exemplary embodiment of the present invention.

Referring to FIG. 8, in a resource element of a size of k×i, reference signals for a relevant antenna port exist with a predetermined pattern. At this point, stream DFT may be usefully employed when RS information excluding a data region is extracted. Also, when, for DC offset calculation, stream DFT is used for a case where k=0, an amount of change of sample-by-sample DC can be measured, and it coincides with a calculating method in a time axis when normalization is considered.

Though exemplary embodiments of the present invention have described DFT, IDFT can be processed in a similar way.

As described above, DFT of smaller complexity compared with the related art is realized by analyzing a correlation between N sampling data inputs {x[n], x[n+1], x[n+2], . . . , x[n+N−1]} and {x[n+1], x[n+2], . . . , x[n+N]}, so that a complexity of a stream DFT operation can be reduced.

While the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described exemplary embodiments but should be determined by not only the appended claims but also the equivalents thereof.

What is claimed is:

1. A Discrete Fourier Transform (DFT) apparatus comprising:
a first delay for delaying one sampling data by N-sample in a time axis when the one sampling data is input;
a second delay for delaying an output value of a frequency component for a previous sampling data by 1-sample;
an operator for performing an operation based on the input one sampling data, the one sampling data delayed by the N-sample in the time axis, and the 1-sample delayed output value of the frequency component for the previous sampling data; and
a multiplier for multiplying an output value from the operator by a twiddle factor
$${e}^{j \frac{2 π kn}{N}} .$$

2. The apparatus of claim 1, wherein an output value of the multiplier is expressed by the equation:
$${X}_{n + 1} [ k ] = ( {X}_{n} [ k ] - x [ n ] + x [ n + N ] ) {e}^{j \frac{2 π kn}{N}}$$
$$for k = 0 , … , N - 1$$
where k is a subcarrier index, Xₙ₊₁[k] is an output value for a k subcarrier in the frequency axis when (n+1)-th sampling data is input, x[n] is n-th sampling data value in the time axis, and
$${e}^{j \frac{2 π kn}{N}}$$
is a twiddle factor.

3. The apparatus of claim 1, wherein the operator comprises one addition operator and one subtraction operator.

4. The apparatus of claim 1, wherein N is a size of a Discrete Fourier Transform (DFT).

5. A Discrete Fourier Transform (DFT) apparatus, the apparatus comprising:
a first delay for delaying one sampling data by N-sample in a time axis when the one sampling data is input;
a plurality of second delays for delaying an output value of a frequency component for a previous sampling data by 1-sample;
a plurality of operators for performing an operation based on the input one sampling data, the one sampling data delayed by the N-sample in the time axis, and the 1-sample delayed output value of the frequency component for the previous sampling data; and
a plurality of multipliers for multiplying each of output values from the plurality of operators by a twiddle factor
$${e}^{j \frac{2 π kn}{N}} .$$

6. The apparatus of claim 5, wherein an output value of each of the plurality of multipliers is expressed by the equation:
$${X}_{n + 1} [ k ] = ( {X}_{n} [ k ] - x [ n ] + x [ n + N ] ) {e}^{j \frac{2 π kn}{N}}$$
$$for k = 0 , … , N - 1$$
where k is a subcarrier index, Xₙ₋₁[k] is an output value for a k subcarrier in the frequency axis when (n+1)-th sampling data is input, x[n] is n-th sampling data value in the time axis, and
$${e}^{j \frac{2 π kn}{N}}$$
is a twiddle factor.

7. The apparatus of claim 5, wherein each of the plurality of operators comprises one addition operator and one subtraction operator.

8. The apparatus of claim 1, wherein N is a size of a DFT.

9. A Discrete Fourier Transform (DFT) method, the method comprising:
when one sampling data is input, delaying, at a first delay, the one sampling data by N-sample in a time axis;
delaying, at a second delay, an output value of a frequency component for a previous sampling data by 1-sample;
performing, at an operator, an operation based on the input one sampling data, the one sampling data delayed by the N-sample in the time axis, and the 1-sample delayed output value of the frequency component for the previous sampling data; and
multiplying, at a multiplier, an output value from the operator by a twiddle factor
$${e}^{j \frac{2 π kn}{N}} .$$

10. The method of claim 9, wherein an output value of the multiplier is expressed by the equation:
$${X}_{n + 1} [ k ] = ( {X}_{n} [ k ] - x [ n ] + x [ n + N ] ) {e}^{j \frac{2 π kn}{N}}$$
$$for k = 0 , … , N - 1$$
where k is a subcarrier index, Xₙ₊₁[k] is an output value for a k subcarrier in the frequency axis when (n+1)-th sampling data is input, x[n] is n-th sampling data value in the time axis, and
$${e}^{j \frac{2 π kn}{N}}$$
is a twiddle factor.

11. The method of claim 9, wherein the operator comprises one addition operator and one subtraction operator.

12. The apparatus of claim 9, wherein N is a size of a DFT.
